(19) United States
(12) Patent Application Publication
(10) Pub. No.: US 2010/0053123 A1
(43) Pub. Date: Mar. 4, 2010

(54) Display device and method for data transmission to display panel driver

(75) Inventor: Yoshihiko Hori, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/461,827

(22) Filed: Aug. 25, 2009

(30) Foreign Application Priority Data
Aug. 29, 2008 (JP) 2008-222453

(51) Int. Cl. G09G 5/00

(52) U.S. Cl. 345/204

(57) ABSTRACT

A display device is provided with a display panel; a driver driving the display panel; and a control apparatus transmitting image data and control data to the driver by using an image data signal. The driver includes a PLL circuit which performs clock data recovery from the image data signal and is configured to drive the display panel in response to the image data. The control data include: drive timing data indicating to start driving display elements within the display panel; and PLL control data which are specific data used to control a frequency and/or phase of the PLL circuit. The control apparatus is configured to transmit the PLL control data after transmission of the drive timing data.

### INCORPORATION BY REFERENCE

This application claims the benefit of priority based on Japanese Patent Application No. 2008-222453, filed on Aug. 29, 2008, the disclosure of which is incorporated herein by reference.

### BACKGROUND OF THE INVENTION

1. Field of the Invention

The present invention relates to a display device and method for data transmission to a display panel driver, more particularly, to clock data recovery (CDR) from image data signal used for transmitting image data.

2. Description of Related Art

One requirement imposed on a display device is reduction in the number of signal lines connected to a display panel driver which drives a display panel (such as a liquid crystal display (LCD) panel). For example, a liquid crystal display device preferably has a reduced number of signal lines connected between an LCD controller and a data line driver. The reduction in the signal lines contributes the reduction in the cost, weight and size of the display device.

One approach for reducing the number of signal lines is clock data recovery from an image data signal used for transmitting image data. This approach eliminates the need for transmitting the image data signal and the clock signal through separate signal lines, effectively reducing the number of signal lines. Such technique is disclosed in Seiichi Ozawa et al. “A Wide Band CDR for Digital Video Data transmission”, A-SSCC 2005, 12-2, pp. 33-36 (2005), for example.

FIG. 1 shows a typical configuration of a display device in which a clock signal is recovered from an image data signal in a display panel driver. The display device of FIG. 1 is provided with a control apparatus 101, a driver 102 and a display panel 103 within which display elements are arranged in rows and columns. The display panel 103 may be an LCD panel, an OLED (organic light emitting diode) display panel, or a field emission display panel.

The control apparatus 101 is provided with an image data processing circuit 111, a transmitter 112, and a PLL (phase locked loop) circuit 113. The image data processing circuit 111 receives an external image signal 104 and generates image data to be transmitted to the driver 102 from the external image signal 104. The transmitter 111 encodes the image data, and thereby generates an image data signal 105. The transmitter 112 transmits the image data signal 105 to the driver 102 in synchronization with a clock signal received from the PLL circuit 113.

The image data signal 105 is generated in a format in which clock data recovery can be implemented within the driver 102. In other words, the image data signal 105 is superposed with a clock signal. Other control data used for controlling the driver 102 are also incorporated into the image data signal 105 in addition to the image data and the clock signal.

The driver 102 is responsive to the image data signal 105 received from the transmitter 112 for driving the display elements within the display panel 103. In detail, the driver 102 is provided with a receiver 121, a PLL circuit 122, and a display element driver circuit 123. The receiver 121 receives the image data signal 105 and decodes the received image data signal 105 to reproduce the image data. The reproduced image data are fed to the display element driver circuit 123. In FIG. 1, the reproduced image data are denoted by the numeral 126. The display element driver circuit 123 generates display element drive signals 106 from the image data 126 and feeds the generated display element drive signals 106 to the display panel 103. This results in that desired display elements are driven.

The reception of the image data signal 105 by the receiver 121 is synchronous with a recovered clock 125 fed from the PLL circuit 122. In detail, the receiver 121 forwards the received image data signal 105 to the PLL circuit 122 with the waveform unchanged. In FIG. 1, the image data signal 105 forwarded to the PLL circuit 122 is referred to as the clock data recovery signal 124. The PLL circuit 122 performs clock data recovery from the clock data recovery signal 124 to generate the recovered clock 125. The receiver 121 receives the recovered clock 125 from the PLL circuit 122 and receives the image data signal 105 so that the sampling timings of the image data signal 105 are synchronized with the recovered clock 125.

In addition, the receiver 121 generates a driving timing signal 127 indicative of the driving timings of the display elements within the display panel 103 in response to the control data incorporated within the image data signal 105. Furthermore, the receiver 121 generates a clock signal 128 synchronous with the recovered clock 125 and feeds the clock signal 128 to the display element driver circuit 123.

FIG. 2 is a timing chart illustrating the drive timings of the display elements by the display element driver circuit 123. The drive timing signal 127 is activated just after transmission of image data associated with display elements in a certain horizontal line is completed. In response to the activation of the driving timing signal 127, the display elements associated with the relevant image data are driven. In other words, the display element drive signals 106 fed to the display panel 103 are driven to the signal levels indicated by the image data to drive the relevant display elements.

One issue of a display device thus constructed is that large noises are generated on the ground line and the power supply line by currents which flow when the drive of the display elements is started, and the noises causes undesired variations in the oscillation frequency and phase of the PLL circuit 122. Referring back to FIG. 2, large currents are generated within the driver 102 due to the large changes in the signal levels of the display element drive signals, when the drive of the display elements is started. These currents cause instantaneous changes in the voltage levels on the ground line and the power supply line. That is, large noises are generated on the ground line and the power supply line. These noises may cause undesired variations in the oscillation frequency and phase of the PLL circuit 122. Once the oscillation frequency and phase of the PLL circuit 122 are changed, the driver 102 may suffer from a malfunction until the oscillation frequency and phase are appropriately regulated again. For example, the sampling timings of the image data signal 105 may be incorrectly indicated and this may cause errors in receiving image data and/or control data. According to an inventor's study, such malfunction can be avoided by quickly remedying the variations in the oscillation frequency and/or phase of the PLL circuit 122 caused by the noises generated by the currents which flows when the drive of the display elements is started.

### SUMMARY OF THE INVENTION

In an aspect of the present invention, a display device is provided with a display panel; a driver driving the display panel; and a control apparatus transmitting image data and control data to the driver by using an image data signal. The driver includes a PLL circuit which performs clock data recovery from the image data signal and is configured to drive the display panel in response to the image data. The control data include: drive timing data indicating to start driving display elements within the display panel; and PLL control data which are specific data used to control a frequency and/or phase of the PLL circuit. The control apparatus is configured to transmit the PLL control data after transmission of the drive timing data.

The display device of the present invention, which is designed to transmit the PLL control data, allows quickly remedying the variations in the oscillation frequency and/or phase of the PLL circuit 122 caused by the noises generated by the currents which flows when the drive of the display elements is started.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram illustrating a typical configuration of a display device adapted to clock data recovery from an image data signal;

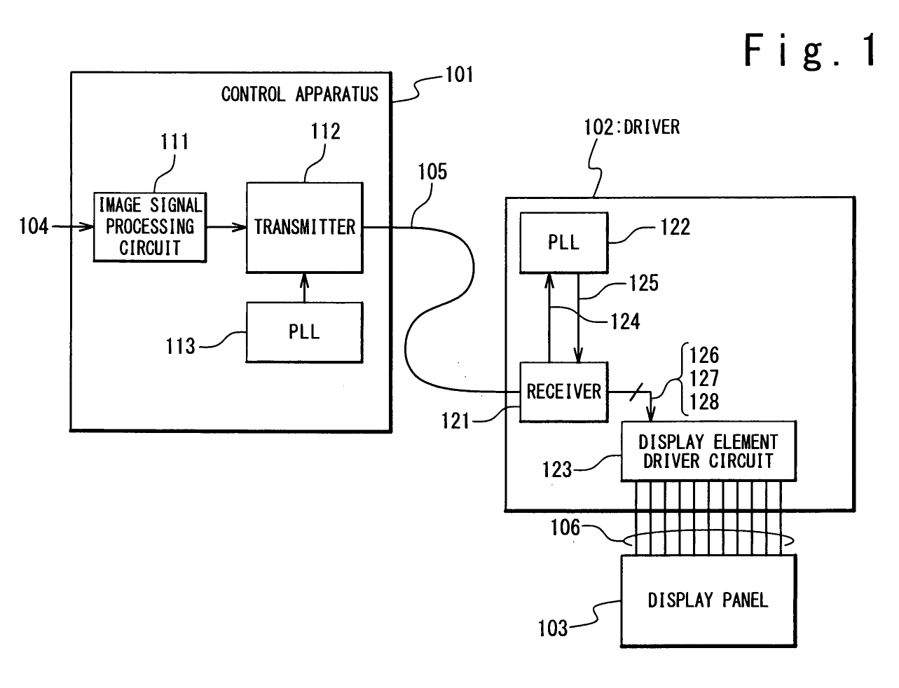

FIG. 2 is a timing chart illustrating an exemplary operation of the display device shown in FIG. 1;

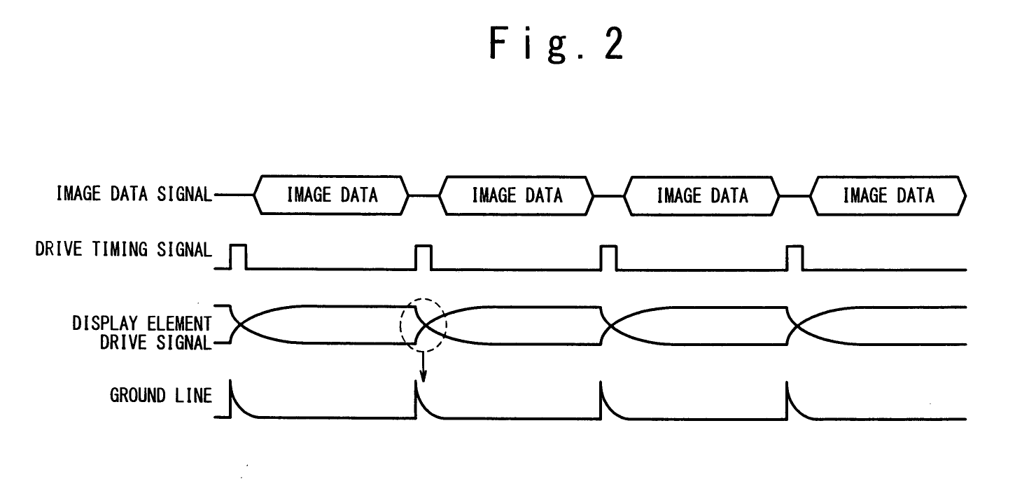

FIG. 3 is a block diagram illustrating an exemplary configuration of a display device in one embodiment of the present invention;

FIG. 4 is a timing chart illustrating an exemplary operation of the display device shown in FIG. 3;

FIG. 5 is a timing chart illustrating details of the display device operation shown in FIG. 4; and

FIG. 6 shows an example of PLL control data.

### DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

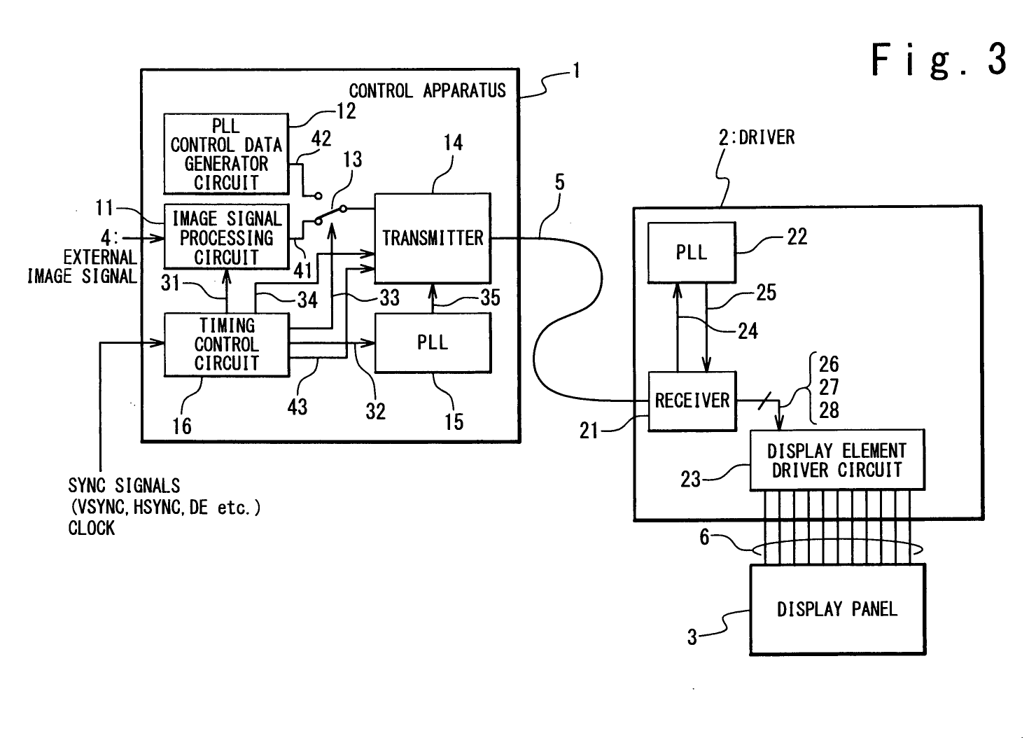

FIG. 3 is a block diagram illustrating an exemplary structure of a display device in one embodiment of the present invention. The display device of this embodiment is provided with a control apparatus 1, a driver 2, and a display panel 3 within which display elements are arranged in rows and columns. The display panel 3 may be an LCD panel, an OLED display panel or a field emission display panel. For a case where the present invention is implemented as a liquid crystal display apparatus, an LCD panel is used as the display panel 3, an LCD controller is used as the control apparatus 1, and a source driver (or a data line driver) is used as a driver 2.

The control apparatus 1 is provided with an image signal processing circuit 11, a PLL control data generator circuit 12, a switch 13, a transmitter 14, a PLL circuit 15 and a timing control circuit 16. The image data processing circuit 11 receives an external image signal 4 and generates from the external image signal 4 image data 41 to be transmitted to the driver 2.

The PLL control data generator circuit 12 generates PLL control data, which are data used for controlling the oscillation frequency and phase of a PLL circuit integrated within the driver 2. As described later, the PLL control data 42 are transmitted to the driver 2 and used to control the oscillation frequency and phase of the PLL circuit integrated within the driver 2. Details of the PLL control data 42 are described later.

The switch 13 is responsive to a switch control signal 33 received from the timing control circuit 16 for selectively forwarding to the transmitter 14 the image data 41 received from the image data processing circuit 11 and the PLL control data 42 received from the PLL control data generator circuit 12.

The transmitter 14 generates an image data signal 5 by encoding the image data 41 received from the image data processing circuit 11, and transmits the generated image data signal 5 to the driver 2. The transmission of the image data signal 5 to the driver 2 is synchronous with a clock signal 35 received from the PLL circuit 15. The image data signal 5 is generated by the transmitter 14 in a format which allows clock data recovery in the driver 2. In other words, a clock signal is incorporated within the image data signal 5. The incorporation of the clock signal is important for implementing clock data recovery in the driver 2.

The timing control circuit 16 is responsive to an external clock signal and synchronization signals fed thereto (such as a vertical sync signal VSYNC, a horizontal sync signal HSYNC, and a data enable signal DE) for controlling the control apparatus 1 and the driver 2. In detail, the timing control circuit 16 feeds timing control signals 31 and 32 to the image signal processing circuit 11 and PLL circuit 15, respectively, to control the operation timings thereof. In addition, the timing control circuit 16 feeds a switch timing control signal to the switch 13 to control the switching timings of the switch 13. Furthermore, the timing control circuit 16 feeds a transmitter control signal 34 to the transmitter 14 to thereby control the transmitter 14. Besides, the timing control circuit 16 controls the timings at which the driver 2 drives the display elements within the display panel 3. More specifically, the timing control circuit 16 generates drive timing data 43 indicative of the drive timings of the driver 2, and feeds the generated drive timing data 43 to the transmitter 14. The transmitter 14 transmits the drive timing data 43 to the driver 2 at proper timings under the control of the transmitter control signal 34.

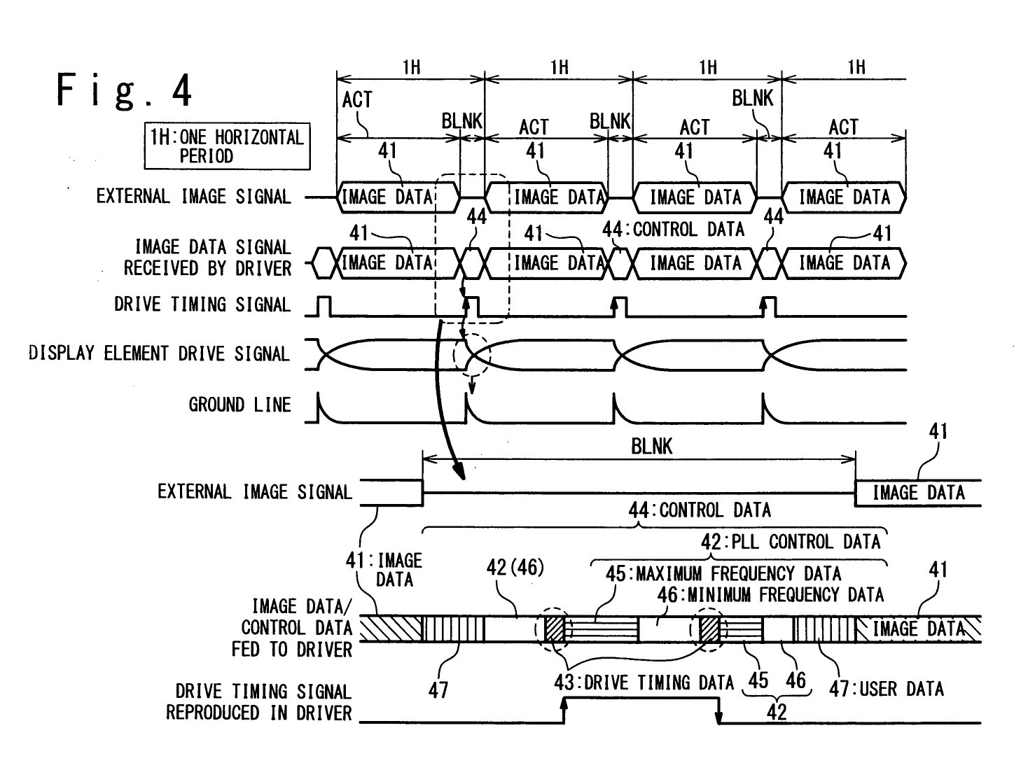

As shown in FIG. 4, the image data signal 5 generated by the transmitter 14 incorporates the control data 44. As described later in detail, the above-described PLL control data 42 and drive timing data 43 are incorporated into the control data 44, and the control data 44 are used for controlling the operation of the driver 2.

Referring back to FIG. 3, the driver 2 drives the display elements within the display panel 3 in response to the image data signal 5 fed thereto. In detail, the driver 2 is provided with a receiver 21, a PLL circuit 22 and a display element driver circuit 23. The receiver 21 receives the image data signal 5, decodes the image data signal 5 to reproduce the image data, and feeds the reproduced image data to the display element driver circuit 23. In FIG. 3, the reproduced image data are denoted by the numeral 26. The display element driver circuit 23 generates display element drive signals 6 in response to the image data 26 and feeds the generated the display element drive signals 6 to the respective data lines of the display panel 3 to drive selected ones of the display elements within the display panel 3.

The receiver 21 receives the image data signal 5 in synchronization with a reproduced clock 25 fed from the PLL circuit 22. In detail, the receiver 21 forwards the received image data signal 5 to the PLL circuit 22 with the waveform thereof unchanged. In FIG. 3, the image data signal 5 forwarded to the PLL circuit 22 is referred to as the clock data recovery signal 24. The PLL circuit 22 performs the clock data recovery from the clock data recovery signal 24 to generate the reproduced clock 25. In generating the reproduced clock 25, the PLL circuit 22 compares the edge positions of the clock data recovery signal 24 and the reproduced clock 25 and adjusts the frequency and phase of the reproduced clock 25 so that the edge positions of the clock data recovery signal 24 are coincident with those of the reproduced clock 25. The receiver 21 receives the reproduced clock 25 from the PLL circuit 22 and samples the image data signal 25, synchronizing the sampling timings of the image data signal 25 with the reproduced clock 25.

In addition, the receiver 21 generates a drive timing signal 27 indicating the drive timings of the display elements within the display panel 3 in response to the control data 44 incorporated within the image data signal 5. Furthermore, the receiver 21 feeds a clock signal 28 from the reproduced clock 25 fed from the PLL circuit 25.

Next, a description is given of an exemplary operation of the display device in this embodiment.

One feature of the display device of this embodiment is that the PLL control data are fed to the driver 2 to thereby remedy the variations in the frequency and/or phase of the reproduced clock 25 caused by the noise generated by the currents in driving the display elements. The PLL control data 42 are specific data defined so that the waveform of the image data signal 5 (that is, the clock data recovery signal 24) is suitable for controlling the frequency and phase of the reproduced clock 25. It should be noted that the PLL control data 42 are not used for other purposes; the PLL control data 42 are dedicatedly used for controlling the frequency and phase of the reproduced clock 25. In the display device of this embodiment, the frequency and phase of the reproduced clock 25 are remedied as early as possible by performing clock data recovery by using the PLL control data 44 after the initiation of the drive of the display elements.

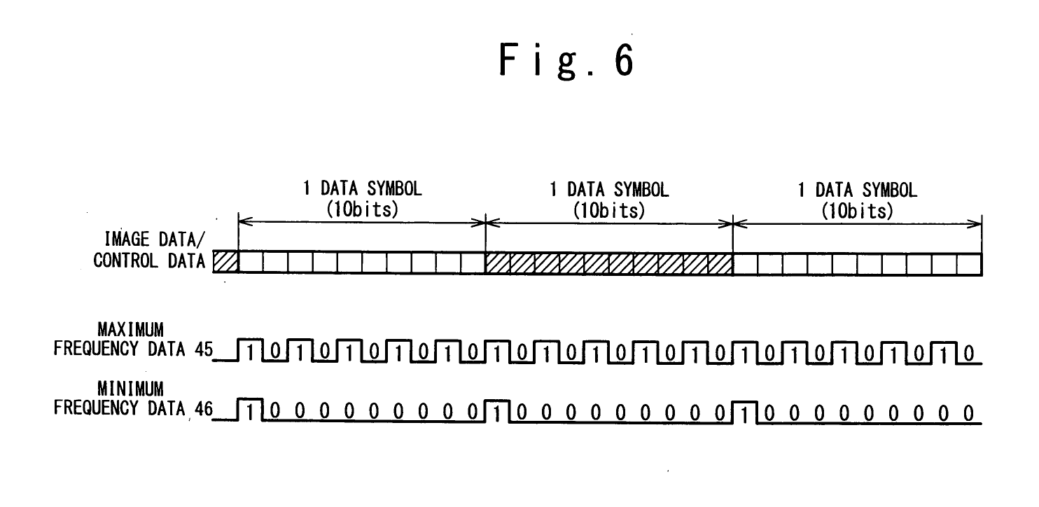

FIG. 6 shows an example of the PLL control data 42. In FIG. 6, an exemplary format of the PLL control data 42 is shown for a case where the image data 41 and the control data 44 (including the PLL control data 42) are 10-bit data, that is, each data symbol of the image data 41 and the control data 44 are composed of 10 data bits. In the following, a transmission cycle period means a cycle period at which data symbols are transmitted over the image data signal 5; one data symbol (that is, 10-bit data) are transmitted in each transmission cycle period. In the example of FIG. 6, the bit width of the image data signal 5 is one, and the transmission of each data symbol are achieved by serially transmitting 10 data bits. Furthermore, bit “1” corresponds to the “high” level in the image data signal 5, and bit “0” to the “low” level. The person skilled in the art would appreciate that the number of data bits included in one data symbol is not limited to 10.

In this case, the image data signal 5, that is, the clock data recovery signal 24 has the maximum number of rising and falling edges in each transmission cycle period, when maximum frequency data 45 consisting of one or more data symbols in which bits “1” and “0” are alternately repeated are transmitted as the PLL control data 42. The use of the clock data recovery signal 24 with such waveform for clock data recovery allows quickly remedying the oscillation frequency of the PLL circuit 24 (that is the frequency of the recovered clock 25). In FIG. 6, the maximum frequency data 45 are shown as being composed of data symbols having a value of “1010101010”. The maximum frequency data 45 may be composed of data symbols having a value of “00101010101”.

When minimum frequency data 46 consisting of one or more data symbols in which the leading bit is “1” and the remaining bits are “0” are repeatedly transmitted as the PLL control data 42, on the other hand, the generation cycle period of the rising edges are coincident with the transmission cycle period and the positions of the rising edges are coincident with the start timings of the respective transmission cycle periods. The clock data recovery signal 24 with such waveform is suitable for stabilizing the phase of the recovered clock 25 and for facilitating the detection of the position of the leading bit of each data symbol, when the PLL circuit 22 is configured to control the frequency and phase of the recovered clock 25 so that the rising edge positions of the clock data recovery signal 24 are coincident with those of the recovered clock 25. In FIG. 6, the minimum frequency data 46 are shown as consisting of data symbols each having a value of “1000000000”.

Alternatively, minimum frequency data 46 consisting of one or more data symbols in which the leading bit is “0” and the remaining bits are “1” may be repeatedly transmitted as the PLL control data 42 so that the generation cycle period of the falling edges are coincident with the transmission cycle period and the positions of the falling edges are coincident with the start timings of the respective transmission cycle periods. The clock data recovery signal 24 with such waveform is suitable for stabilizing the phase of the recovered clock 25 and for facilitating the detection of the position of the leading bit of each data symbol, when the PLL circuit 22 is configured to control the frequency and phase of the recovered clock 25 so that the falling edge positions of the clock data recovery signal 24 are coincident with those of the recovered clock 25.

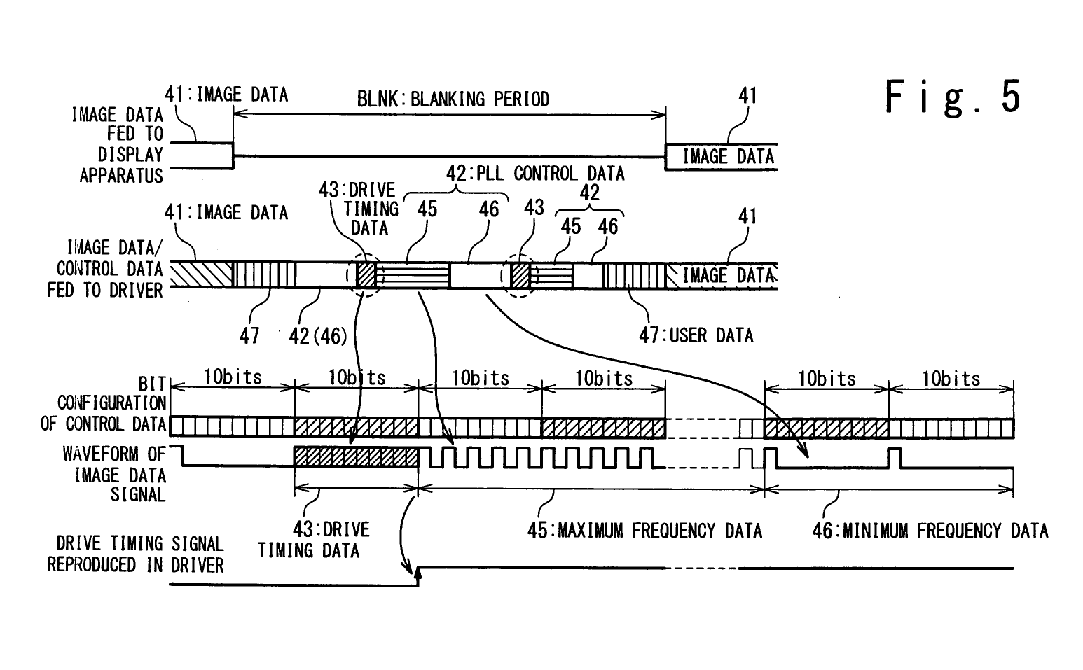

In the following, a detailed description is given of the operation of the display apparatus of this embodiment with reference to FIGS. 4 and 5. As shown in FIG. 4, each horizontal period includes an active period ACT in which the image data 41 are transmitted and a blanking period BLNK. The control apparatus 1 transmits the control data 44, which include the drive timing data 43 and PLL control data 42. The control data 44 may additionally include other user data in addition to the drive timing data 43 and the PLL control data 42. In FIG. 4, the user data incorporated into the control data 44 are denoted by the numeral 47.

The drive timing data 43 are used for the control apparatus 1 to control the drive timings of the display elements within the display panel 3. In this embodiment, in which the display element driver circuit 23 in the driver 2 are configured to start driving selected display elements in response to the activation of the drive timing signal 27, the control apparatus 1 controls the activation and deactivation of the drive timing signal 27 of the driver 2 by transmitting the drive timing data 43.

In detail, the control apparatus 1 transmits drive timing data 43 at the timing at which the drive timing signal 27 is to be activated in each blanking period, and transmits drive timing data 43 once again at the timing at which the drive timing signal 27 is to be deactivated. The receiver 21 activates the drive timing signal 27 when first detecting the drive timing data 43 in a certain blanking period BLNK. The value of the drive timing data 43 are define as a specific value. When a value of a data symbol transmitted to the receiver 21 by the image data signal 5 is the specific value, the receiver 21 judges that drive timing data 43 are fed thereto and activates the drive timing signal 27.

The display element driver circuit 23 starts driving display elements in the selected line within the display panel 3 in response to the image data 41 transmitted in the just previous active period ACT, when detecting the activation of the drive timing signal 27. In detail, the display element driver circuit 23 sets the display element drive signals 6 to the signal levels corresponding to the values of the image data 41 transmitted in the just previous active period ACT to thereby drive the display elements in the selected line. That is, the drive timing data 43 firstly transmitted and detected are used for the control apparatus 1 to indicate to start driving the display elements in the selected line. When then detecting drive timing data 43 again, the receiver 21 deactivates the drive timing signal 27.

As described above, the frequency and phase of the recovered clock 25 generated by the PLL circuit 22 may vary from the frequency and phase suitable for the reception of the image data signal 5 due to the noises generated on the ground line and power supply line by the currents flowing when the drive of the display elements is started. In order to avoid this problem, the control apparatus 1 transmits the PLL control data 42 after transmitting the drive timing data 43 indicating the activation of the drive timing signal 27. As described above, the PLL control data 42 are composed of specific data symbols suitable for clock data recovery, and the transmission of the PLL control data 42 just after the start of the drive of the display elements allows quickly recovering the frequency and phase of the recovered clock 25 generated by the PLL circuit 22 to the frequency and phase suitable for the reception of the image data signal 5.

It is significant that the PLL control data 42 are transmitted after the drive of the display elements is started and before the next image data 41 are then transmitted. This allows quickly recovering the frequency and phase of the recovered clock 25 to the frequency and phase suitable for the reception of the image data signal 5 before the reception of the next image data 41, improving the reliability of the reception of the image data 41. In the operation shown in FIG. 4, the PLL control data 42 are transmitted twice after the drive timing data 43 are first transmitted and before the next image data 41 are then transmitted, and this effectively improves the reliability of the reception of the image data 41.

It is more preferable that the PLL control data 42 are transmitted after the drive of the display elements is started (that is, after the drive timing data 43 are first transmitted in the blanking period) and before valid data to be next received by the receiver 21 are transmitted. It should be noted that the valid data to be next received means control data actually used for the control of the driver 2 (other than the PLL data 42). In the example of FIG. 4, drive timing data 43 indicating the deactivation of the drive timing signal 27 are transmitted as the valid data, after drive timing data 43 are first transmitted in the blanking period. The PLL control data 42 are transmitted after the drive timing data 43 indicating the activation of the drive timing signal 27 are transmitted and before the drive timing data 43 indicating the deactivation of the drive timing signal 27 are then transmitted, and this effectively improves the reception reliability of the drive timing data 43 indicating the deactivation of the drive timing signal 27.

It is preferable that the PLL control data 42 are transmitted just after the drive of the display elements is started. In other words, it is preferable that, the PLL control data 42 are transmitted just after the drive timing data 43 are first transmitted in the blanking period. This allows recovering the frequency and phase of the recovered clock 25 to the frequency and phase suitable for the reception of the image data signal 5, more quickly.

The PLL control data 42 may be also transmitted before the start of the drive of the display elements, in addition to after the start of the drive of the display elements. This increases the length of the period during which the frequency and phase of the recovered clock 25 are effectively adjusted, improving the stability of the frequency and phase of the recovered clock 25. In the example shown in FIG. 4, the PLL control data 42 are also transmitted before the transmission of the data timing data 43 indicating the activation of the drive timing signal 27.

The PLL control data 42 may include the maximum frequency data 45 and/or the minimum frequency data 46 shown in FIG. 6. It should be noted that the maximum frequency data 45 are data having a value determined so that the number of the rising and falling edges of the image data signal 5 (that is, the clock data recovery signal 24) is maximum, while the minimum frequency data 46 are data having a value determined so that the generation cycle period of the rising edges or falling edges of the clock data recovery signal 24 is coincident with the transmission cycle period, and the positions of the rising or falling edges are coincident with the start timings of the respective transmission cycle periods. Preferably, the PLL control data 42 include both of the maximum frequency data 45 and the minimum frequency data 46. In the example shown in FIG. 4, both of the maximum frequency data 45 and the minimum frequency data 46 are incorporated into the PLL control data 42 transmitted between the transmission of the drive timing data 43 indicating the activation of the drive timing signal 27 and the transmission of the next image data 41, while only the minimum frequency data 46 are incorporated into the PLL control data 42 transmitted before the drive timing data 43 indicating the activation of the drive timing signal 27.

It is preferable that, when the PLL control data 42 include both of the maximum frequency data 45 and the minimum frequency data 46, the maximum frequency data 45 are first transmitted, and the minimum frequency data 46 are then transmitted after the transmission of the maximum frequency data 45. This is because, when the oscillation frequency and phase of the PLL circuit 22 are once varied, it is desirable that the oscillation frequency is first remedied.

FIG. 5 is a timing chart illustrating details of the operation of the display device in a case where the maximum frequency data 45 are first transmitted as the PLL control data 42 after the transmission of the drive timing data 43 indicating the activation of the drive timing signal 27, and then the minimum frequency data 46 are transmitted. It should be noted that FIG. 5 illustrates the operation for the case where the PLL circuit 22 is configured to control the frequency and phase of the recovered clock 25 by comparing the rising edges of the clock data recovery signal 24 and the recovered clock 25. When the blanking period is started, the drive timing data 43 are transmitted at the timing at which the drive of the display elements is to be started. As a result, the drive timing signal 27 in the driver 2 is activated to start the drive of the display elements. This is followed by transmitting the maximum frequency data 45. In the operation shown in FIG. 5, the maximum frequency data 45 are composed of a series of data symbols each having a value of “1010101010”. When the maximum frequency data 45 are transmitted, the number of the rising edges is increased to the maximum value in the image data signal 5 (that is, the clock data recovery signal 24); the frequency of the rising edges is maximum. Transmitting the maximum frequency data 45 thus defined allows quickly recovering the frequency of the recovered clock 25, which suffers from the frequency variation from the desired value due to the start of the drive of the display elements. This is followed by transmitting the minimum frequency data 46. In the operation shown in FIG. 5, the minimum frequency data 46 are composed of a series of data symbols each having a value of “1000000000”. Transmitting the minimum frequency data 46 thus defined allows stabilizing the phase of the recovered clock 25 and detecting the leading bit of each data symbol.

As thus described, the display device of this embodiment is configured to feed the PLL control data 42 to the driver 2 after the drive of the display elements is started, and to thereby quickly remedy variations of the frequency and/or phase of the recovered clock 25 caused by the noises generated by the currents flowing when the display elements are driven.

Although embodiments of the display device according to the present invention are specifically described above, the person skilled in the art would appreciate that the present invention is not limited to the above-described embodiments; the present invention may be implemented with various changes or modifications. It should be especially noted that the person skilled in the art would appreciate that the functions of the control apparatus 1 may be realized by hardware, software or a combination thereof, although the functions of the control apparatus 1 are described as being realized by hardware in the above-described embodiments.

What is claimed is:

1. A display device comprising:
a display panel;
a driver driving said display panel; and
a control apparatus transmitting image data and control data to said driver by using an image data signal,
wherein said driver includes a PLL circuit which performs clock data recovery from said image data signal and is configured to drive said display panel in response to said image data,
wherein said control data include:
drive timing data indicating to start driving display elements within said display panel; and
PLL control data which are specific data used to control a frequency and/or phase of said PLL circuit, and
wherein said control apparatus is configured to transmit said PLL control data after transmission of said drive timing data.

2. The display device according to claim 1, wherein said image data and said control data include data symbols each comprising a predetermined number of data bits,
wherein said data symbols are transmitted in transmission cycle periods of said image data signal, respectively, and
wherein said PLL control data include maximum frequency data defined so that a number of edges of said image data signal in each of said transmission cycle periods is maximum.

3. The display device according to claim 2, wherein said PLL control data further include minimum frequency data defined so that a cycle period of rising edges of said image data signal is coincident with said transmission cycle periods and positions of said rising edges are coincident with start timings of said transmission cycle periods, respectively, or so that a cycle period of falling edges of said image data signal is coincident with said transmission cycle periods and positions of said falling edges are coincident with start timings of said transmission cycle periods, respectively.

4. The display device according to claim 2, wherein said maximum frequency data are transmitted after the transmission of said drive timing data, and said minimum frequency data are transmitted after the transmission of said maximum frequency data.

5. The display device according to claim 1, wherein said PLL control data are transmitted after the transmission of said drive timing data and before next image data are then transmitted to said driver.

6. The display device according to claim 5, wherein said PLL control data are transmitted after the transmission of said drive timing data and before valid data actually used for control of said driver are transmitted as said control data.

7. The display device according to claim 6, wherein said PLL control data are transmitted just before said drive timing data.

8. A control apparatus for transmitting an image data signal to a driver driving a display panel and including a PLL circuit which performs clock data recovery from said image data signal, said control apparatus comprising:
a processing circuit feeding image data; and
a transmitter transmitting control data and said image data by using said image data signal,
wherein said control data include:
drive timing data indicating to start driving display elements within said display panel; and
PLL control data which are specific data used to control a frequency and/or phase of said PLL circuit, and
wherein said transmitter is configured to transmit said PLL control data after transmission of said drive timing data.

9. A data transmitting method for transmitting an image data signal to a driver driving a display panel and including a PLL circuit which performs clock data recovery from said image data signal, said method comprising:
transmitting control data and image data by using said image data signal,
wherein said control data include:
drive timing data indicating to start driving display elements within said display panel; and
PLL control data which are specific data used to control a frequency and/or phase of said PLL circuit, and
wherein said transmitter is configured to transmit said PLL control data after transmission of said drive timing data.

10. The method according to claim 9, wherein said image data and said control data include data symbols each comprising a predetermined number of data bits,
wherein said data symbols are transmitted in transmission cycle periods of said image data signal, respectively, and
wherein said PLL control data include maximum frequency data defined so that a number of edges of said image data signal in each of said transmission cycle periods is maximum.

11. The method according to claim 10, wherein said PLL control data further include minimum frequency data defined so that a cycle period of rising edges of said image data signal is coincident with said transmission cycle periods and positions of said rising edges are coincident with start timings of said transmission cycle periods, respectively, or so that a cycle period of falling edges of said image data signal is coincident with said transmission cycle periods and positions of said falling edges are coincident with start timings of said transmission cycle periods, respectively.

12. The method according to claim 11, wherein said maximum frequency data are transmitted after the transmission of said drive timing data, and said minimum frequency data are transmitted after the transmission of said maximum frequency data.
